(19) United States
(12) Patent Application Publication
(10) Pub. No.: US 2007/0132827 A1
(43) Pub. Date: Jun. 14, 2007

(54) Image drum and method of manufacturing the same

(75) Inventors: Ki Deok Bae, Yongin-si (KR); Kyu Ho Shin, Seoul (KR); Kae Dong Back, Yongin-si (KR); Soon Cheol Kweon, Seoul (KR); Won Kyoung Choi, Suwon-si (KR); Chang Seung Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/481,011

(22) Filed: Jul. 6, 2006

(30) Foreign Application Priority Data
Dec. 14, 2005 (KR) 10-2005-0122876

(51) Int. Cl. G01D 15/06

(52) U.S. Cl. 347/169

(57) ABSTRACT

An image drum device and a method of manufacturing the image drum are provided. The method includes forming electrodes, electrically insulated from each other and disposed parallel to each other, on a flexible substrate; bonding a control unit to the flexible substrate; disposing opposite ends of the flexible substrate to face each other; inserting the control unit and the ends of the flexible substrate into a slit which is longitudinally formed in a drum body; and attaching the flexible substrate to the drum body. The image drum includes a drum body having a slit longitudinally therein; a flexible substrate including electrodes, electrically insulated from each other, disposed parallel to each other, and formed on an outer surface thereof, the flexible substrate attached to and covering the drum body; and a control unit which is inserted into the slit together with opposite ends of an outer surface of the flexible substrate.

### CROSS-REFERENCE TO RELATED APPLICATION

This application claims priority from Korean Patent Application No. 10-2005-0122876, filed on Dec. 14, 2005 in the Korean Intellectual Property Office, the entire disclosure of which is incorporated herein by reference.

### BACKGROUND OF THE INVENTION

1. Field of the Invention

Apparatuses and methods consistent with the present invention relate to an image drum used in a printing device, and more particularly, to an image drum and a method of manufacturing the same, in which an image drum including a ring electrode can be easily fabricated and a manufacturing cost can be reduced.

2. Description of the Related Art

FIG. 1 is a schematic perspective view illustrating a conventional image-forming element according to a conventional art, and FIG. 2 is an enlarged cross-sectional view illustrating a portion of the circumferential wall of the image-forming element according to the conventional art. The image-forming element shown in FIGS. 1 and 2 is disclosed in U.S. Pat. No. 6,014,157, which is incorporated herein by reference.

Referring to FIGS. 1 and 2, the conventional image-forming element 10 comprises a hollow cylindrical drum body 12 which is made of metal, preferably aluminum or an aluminum alloy. A plurality of circumferentially extending electrodes 14 are formed on the outer circumferential surface of the drum body 12. These electrodes 14 are electrically insulated from one another and from the drum body 12 and are covered by a thin layer of dielectric material. The ring electrodes 14 may generally be designed variously depending on the desired resolution of the images to be formed, but are preferably provided densely over the whole length of the drum body 12 in such a fashion as to be arranged with a pitch of, for example, about 40 μm in order to realize a resolution of approximately 600 dpi.

An elongate-shaped control unit 16 is mounted inside of the hollow drum body 12 such that a terminal array 18 formed at a longitudinal edge of the control unit 16 adjoins the internal wall of the drum body 12. The control unit 16 is arranged for individually applying a suitably high voltage to each of the electrodes 14 via the terminal array 18 in accordance with the image formation. As shown in FIG. 2, the individual electrodes 14 are formed as grooves separated by adjacent insulating ridges 20 and are filled internally with electrically conductive material 32. Since the electrically conductive material 32 fills in a small diameter hole 24 and a large diameter hole 26 constituting a through-hole 22, the electrodes 14 are electrically connected to zebra-strips 36 disposed at the inner wall surface of the drum body 12 via the through-hole 22. In this case, an anodized surface layer 34 is present at the outer circumferential surface of the drum body 12 and at the internal wall of the through-holes 22 so as to electrically insulate the drum body 12 and the electrodes 14 from each other.

In order to manufacture the image-forming element 10 the cylindrical drum body 12 is provided. The grooves are cut into the outer circumferential surface of the drum body, for example, by means of a diamond chisel to have a pitch of approximately 40 μm and a width of approximately 20 μm to form the electrodes 14. Alternatively, these grooves may be formed on the outer circumferential surface of the drum body by means of a laser beam or an electron beam.

In the next step, the large diameter holes 26 are cut into the wall of the drum body 12 from inside by, for example, a means for a laser beam. The small diameter holes 24 may also be formed with a laser beam, either from the inside or outside of the drum body to thereby form the through-holes 22. After the through-holes 22 including the small diameter holes 24 and the large diameter holes 26 have been formed, the whole drum body 12 is anodized so as to form the insulating metal oxide layer 34 on the whole surface of the drum body. Thereafter, the electrically conductive material 32 fills in the grooves 14 and the through-holes 22. The outer or inner circumferential surface of the drum body 12 is cut to a predetermined depth through grinding so as to effectuate the electrodes 14 and electrical connection portions inside of the through-holes 22. An insulating layer is formed on the outer circumferential surface of the drum body 12 and the control unit 16 is disposed inside of the drum body 12 so as to complete the manufacture of the image-forming element 10.

As described above, in order to form the electrodes 14 on the outer circumferential surface of the drum body 12, the grooves are densely formed over the whole length of the drum body 12 using a precise cutting tool and the through-holes 22 must be formed at regular intervals either from the inside or outside of the drum body 12. Also, after the formation of the anodized surface layer on the outer circumferential surface of the drum body 12 and at the internal wall of the through-holes 22, the electrically conductive material 32 is filled into the grooves and the through-holes and is removed until a desired thickness remains. Specifically, since it is very difficult to evenly form the grooves on the outer circumferential surface of the drum body 12 in such a fashion as to have a pitch of approximately 40 μm and a width of approximately 20 μm and to fabricate the through-holes 22, a manufacturing cost of the image-forming element 10 is significantly high and defects regularly occur. As mentioned above, there is a disclosed direct induction type image-forming method and apparatus using a ring electrode such as the image-forming element as described above. However, a printer made with the disclosed direct induction type image-forming method and apparatus using a ring electrode as described above is high priced, which makes it difficult for the printer to be popularized.

### SUMMARY OF THE INVENTION

An aspect of the present invention provides an image drum which can be easily fabricated and can enable excellent quality printing, and a method of manufacturing the same.

An aspect of the present invention also provides an image drum which can be rapidly and easily fabricated, is advantageous for mass production, and can reduce a manufacturing cost, and a method of manufacturing the same.

According to an exemplary embodiment of the present invention, a method of manufacturing an image drum is provided. The method includes forming a plurality of electrodes, which are electrically insulated from each other and disposed parallel to each other, on a flexible substrate; bonding a control unit to the flexible substrate; disposing opposite ends of an outer surface of the flexible substrate to face each other; inserting the control unit and the facing opposite ends of the flexible substrate into a slit which is longitudinally formed in a drum body; and attaching the flexible substrate to an outer surface of the drum body.

The plurality of electrodes may be ring electrodes. Array tags may be used in order to precisely arrange the ring electrodes. The array tags may be disposed to be separated from each other at a certain interval and adjacent to the opposite ends of the flexible substrate. Accordingly, the ring electrodes of the flexible substrate may be precisely arranged by disposing the array tags to be aligned with each other.

The control unit and the opposite ends of the flexible substrate may be inserted into a slit longitudinally formed in a drum body to contain the control unit. The control unit and the opposite ends of the flexible substrate may be moved inside the slit and the flexible substrate may be attached to an outer surface of the drum body. When inserting the control unit and the opposite ends of the flexible substrate into the slit, the flexible substrate may be closely attached to the drum body by pulling the array tags inside.

According to another exemplary embodiment of the present invention, an image drum is provided. The image drum includes a drum body having a slit formed longitudinally therein; a flexible substrate including a plurality of electrodes, electrically insulated from each other, disposed parallel to each other, and formed on an outer surface thereof, the flexible substrate attached to and covering the drum body while exposing the plurality of electrodes; and a control unit which is inserted into the slit together with opposite ends of an outer surface of the flexible substrate.

Array tags separated from each other at a certain interval may be provided on facing opposite ends of the flexible substrate, respectively, thereby easily and precisely aligning the ring electrodes of the flexible substrate. The control unit inserted into the slit may be provided on a flexible substrate or a hard substrate.

According to another exemplary embodiment of the present invention, a method of manufacturing an image drum is provided. The method forming a plurality of electrodes, which are insulated from each other and disposed parallel to each other, on a flexible substrate; mounting a control chip on a hard substrate; bonding the control chip and the hard substrate to the flexible substrate; disposing opposite ends of an outer surface of the flexible substrate to face each other; inserting the hard substrate and a part of the flexible substrate to which the hard substrate is bonded into a slit formed longitudinally in a drum body; and attaching the flexible substrate to an outer surface of the drum body.

The plurality of electrodes may be ring electrodes. The hard substrate may be inserted into the slit to be fixed and not to move and swing in the slit. To electrically couple the ring electrodes, the outer surface of opposite ends of the flexible substrate may be disposed to face each other.

Similar to the described method of manufacturing the image drum, when disposing an outer surface of opposite ends of the flexible substrate, on which the ring electrodes are formed, to face each other, array tags separated at a certain interval may be formed on a side of the flexible substrate and the ring electrodes on the flexible substrate may be precisely arranged by disposing the array tags to be aligned with each other. The array tags may be disposed at a side of the opposite ends, respectively.

Also, when inserting the hard substrate and the part of the flexible substrate, with which the hard substrate is connected, into the slit, the flexible substrate may be closely attached to the drum body by pulling the array tags formed on the opposite ends inside.

According to still another exemplary embodiment of the present invention, an image drum manufactured by the described method is provided. The image drum includes a drum body having a slit formed longitudinally therein; a flexible substrate including a plurality of electrodes electrically insulated from each other, disposed parallel to each other, and formed on an outer surface thereof, the flexible substrate attached to and covering the drum body while exposing the plurality of electrodes; and a control unit comprising a control chip and a hard substrate on which the control chip is bonded, the control unit being inserted into the slit together with contact ends of an outer surface of the flexible substrate includes a drum body, a flexible substrate, and a control unit.

The plurality of electrodes may be ring electrodes. The flexible substrate may cover the drum body to expose the ring electrodes. The flexible substrate may be inserted into the slit and attached to the drum body while the outer surface of the opposite ends of the flexible substrate is disposed to face each other.

Also, similar to the described image drum, to precisely arrange the ring electrodes, array tags may be formed. The array tags may be disposed on a side of the flexible substrate, separated from each other at a certain interval.

### BRIEF DESCRIPTION OF THE DRAWINGS

The above and other aspects of the present invention will become apparent and more readily appreciated from the following detailed description, taken in conjunction with the accompanying drawings of which:

FIG. 1 is a schematic perspective view illustrating a conventional image-forming element according to a conventional art;

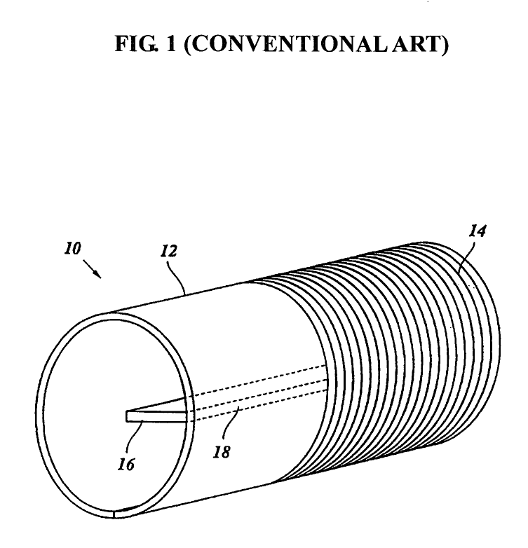

FIG. 2 is an enlarged cross-sectional view illustrating a portion of the circumferential wall of the image-forming element of FIG. 1;

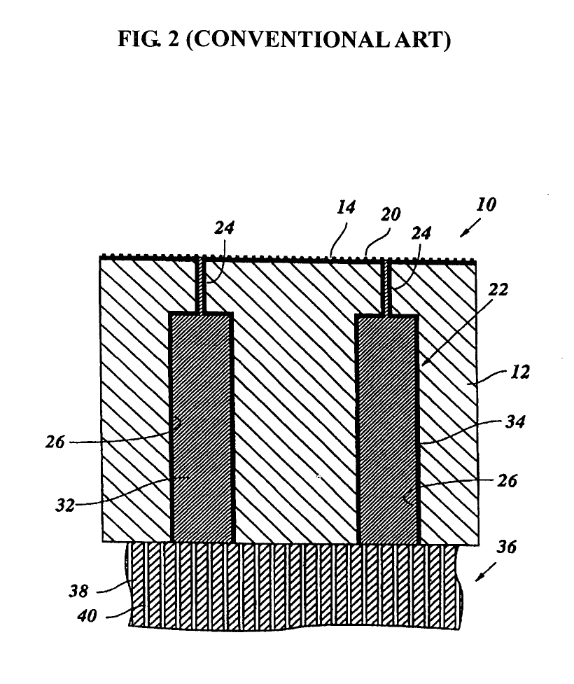

FIG. 3 is a cross-sectional view illustrating an inner configuration of a printer employing an image drum according to a first exemplary embodiment of the present invention;

FIG. 4 is an enlarged perspective view illustrating the image drum of FIG. 3 and a process of manufacturing the image drum;

FIG. 5 is an enlarged perspective view illustrating a flexible substrate of the image drum of FIG. 3;

FIG. 6 is an enlarged perspective view illustrating a drum body of the image drum of FIG. 3;

FIG. 7 is a partial enlarged side view illustrating the image drum of FIG. 3;

FIG. 8 is a top view illustrating a flexible substrate of an image drum according to a second exemplary embodiment of the present invention;

FIG. 9 is a perspective view illustrating a process of manufacturing the image drum according to the second exemplary embodiment of the present invention;

FIG. 10 is a perspective view illustrating a flexible substrate and ring electrodes according to a third exemplary embodiment of the present invention;

FIG. 11 is a partial enlarged cross-sectional view illustrating the image drum according to the third exemplary embodiment of the present invention;

FIG. 12 is a perspective view illustrating a process of manufacturing an image drum according to a fourth exemplary embodiment of the present invention;

FIG. 13 is an enlarged perspective view illustrating a drum body of an image drum according to a fifth exemplary embodiment of the present invention; and

FIG. 14 is a partial enlarged cross-sectional view illustrating the image drum according to the fifth exemplary embodiment of the present invention.

### DETAILED DESCRIPTION OF EXEMPLARY EMBODIMENTS OF THE PRESENT INVENTION

Reference will now be made in detail to certain exemplary embodiments of the present invention, examples of which are illustrated in the accompanying drawings, wherein like reference numerals refer to the like elements throughout. The exemplary embodiments are described below to explain the present invention by referring to the figures.

### Exemplary Embodiment 1

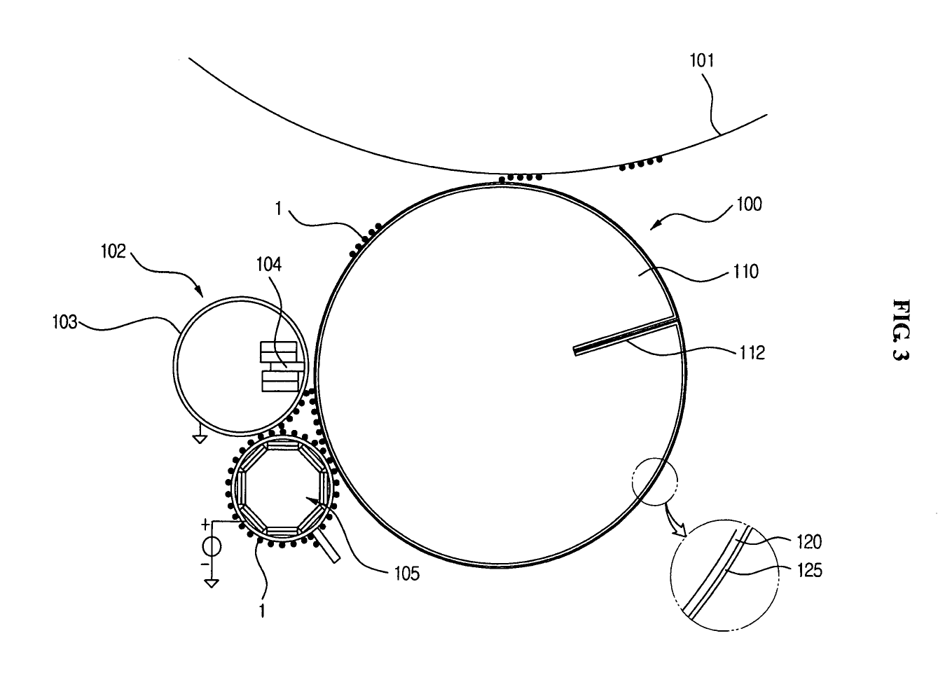

FIG. 3 is a cross-sectional view illustrating an inner configuration of a printer employing an image drum 100 according to a first exemplary embodiment of the present invention.

Referring to FIG. 3, the image drum 100 comprises a cylindrical drum body 110 and an electrode element 120. A toner feed roller 105, a magnetic cutter 102, and an image transfer section 101 are disposed around the outer circumferential surface of the image drum 100. A toner 1 from a toner storage section (not shown) is supplied to the toner feed roller 105, and is transferred to the image drum 100 from the toner feed roller 105 while moving on the outer circumferential surface of the toner feed roller 105. In this case, since the toner is charged with electricity, it may be attached on an insulating layer formed on the outermost circumferential portion of the image drum 100, and it may be selectively transferred from the image drum 100 to the magnetic cutter 102 when passing by the magnetic cutter 102.

The magnetic cutter 102 includes a rotary sleeve 103, and a magnet 104 disposed within the magnetic cutter 102 for applying an attraction force to the toner 1. The magnet 104 is positioned adjacent to the image drum 100 and can attract the toner 1 adhered to the surface of the image drum 100 using a magnetic force. The magnet 104 has sufficient magnetic force which can collect the toner 1 from the electrodes of the image drum 100 which is not applied with a voltage. The toner 1 collected by the magnet 104 is fed back to the toner storage section or the toner feed roller 105 through the rotating sleeve 103.

The toner 1, which is not collected by the magnetic cutter 102, may be transferred to the image transfer section 101 from the outer circumferential surface of the image drum 100. Then, the toner 1 transferred to the image transfer section 101 may be transferred to a printing paper sheet which is in turn heat-treated so as to allow the toner to be adhered to the surface of the printing paper sheet. To this end, the image drum 100 can control the voltage applied to the electrodes to conform to an image signal. Then, the image drum 100 can generate a magnetic force larger than that of the magnet 104 so as to prevent the toner 1 from being collected by the magnetic cutter 102.

Approximately five thousand electrodes are controlled individually so as to represent a two dimensional image on the image drum 100. The image represented on the image drum 100 through the toner 1 can be transferred to the printing paper sheet by using the image transfer section 101 as a relay means. After the toner 1 has been adhered to the surface of the printing paper sheet, the printing paper sheet passes through a heat-treatment device. At this time, the toner is adsorbed to the surface of the printing paper sheet to complete a corresponding printing.

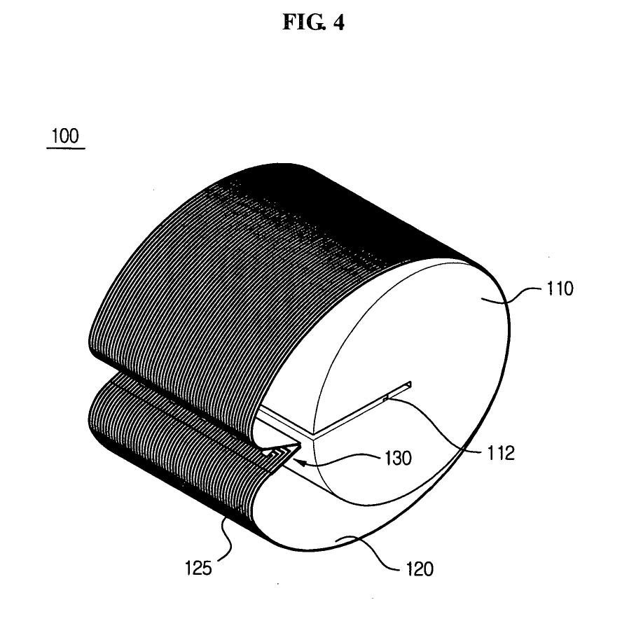

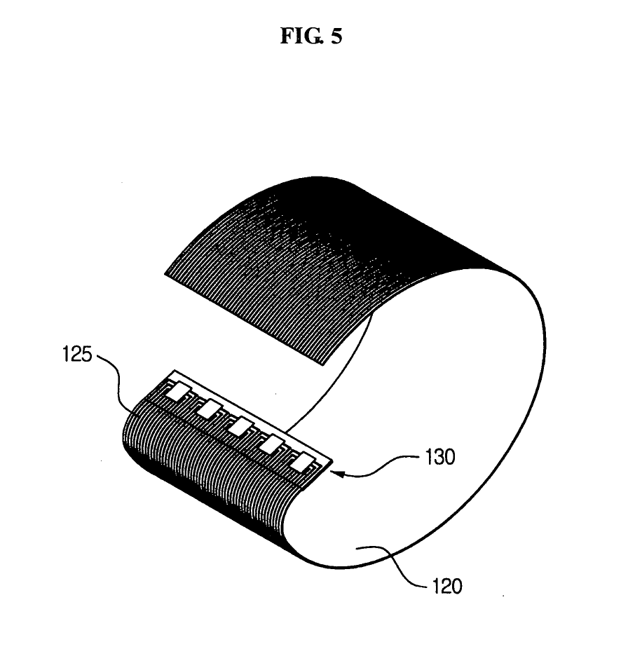

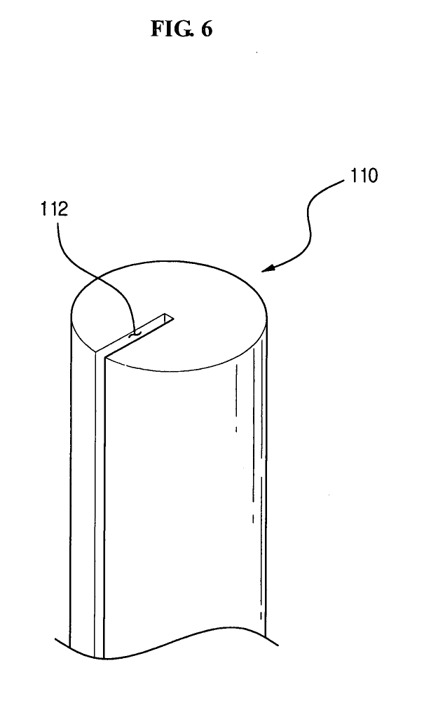

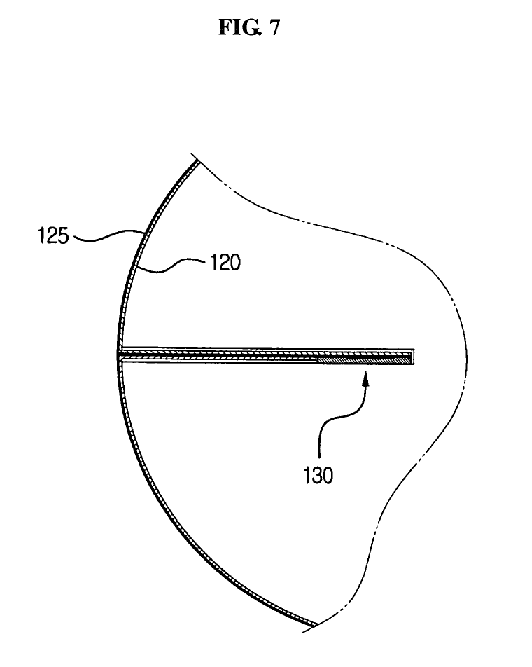

FIG. 4 is a perspective view illustrating the image drum according to a first exemplary embodiment of the present invention and a process of manufacturing the image drum, FIG. 5 is a perspective view illustrating a flexible substrate of the image drum in FIG. 4, FIG. 6 is a perspective view illustrating the drum body of the image drum in FIG. 4, and FIG. 7 is a partial enlarged side view illustrating the image drum 100 in FIG. 4.

Referring to FIGS. 4 through 7, the image drum 100 includes a drum body 110, a flexible substrate 120, and a control unit 130.

The drum body 110 is formed in the shape of a cylinder on which a slit 112 is longitudinally formed. The slit 112 is for inserting and fixing the control unit 130. A thickness of the slit 112 is determined by a thickness of the control unit 130 and the flexible substrate 120 to which the control unit 130 is installed. Also, the flexible substrate 120 is attached to an outer surface of the drum body 110.

The flexible substrate 120 may be formed of a thin insulating film made of a material such as polyimide, or other such thin insulating film known in the art. Conductive patterns may be circumferentially formed on the outer circumferential surface of the flexible substrate 120. The conductive patterns are evenly formed as ring electrodes 125 in such a fashion as to have a pitch of approximately 40 μm and a width of approximately 20 μm. The ring electrodes 125 covering the circumference of the drum body 110 are formed to have a width corresponding to the printing width of the printing paper sheet. For example, assuming a printing paper sheet of A4 size, the drum body 110 is formed to have a length of at least 20 to 22 cm over the whole width thereof. Each of the ring electrodes 125 may be formed to have a pitch of approximately 40 μm to achieve about five thousand lines. The ring electrodes 125 can be formed in a ring structure which is closed as one piece or partially opened. That is, both ends of each of the ring electrodes 125 may be electrically interconnected to form a closed ring structure, but it is possible to electrically insulate both ends of the each ring electrode 125 according to circumstances.

Since the ring electrodes 125 can be formed by patterning copper, or other thin conductive film known in the art, in a flat state, a groove cutting step or a conductive material filling step employed in a conventional image drum manufacturing process can be eliminated. Since it is possible to form the ring electrodes 125 on the planar flexible substrate 120, the level of work difficulty is greatly lowered as compared to a formation of the ring electrodes 125 on the outer circumferential surface of the cylindrical drum body 110, as in the conventional art. Moreover, a defective generation rate of the ring electrodes can be remarkably reduced.

After forming the ring electrodes 125 on the flexible substrate 120, the control unit 130 may be directly bonded to the flexible substrate 120. The control unit 130 is individually connected to each of the ring electrodes 125 and may individually apply a certain voltage to each of the ring electrodes 125. In this first exemplary embodiment, the control unit 130 is installed along an end of the flexible substrate 120 in parallel with the slit 112 into which the control unit 130 is fixed. However, in other exemplary embodiments, control units may be mounted on a hard substrate to be provided.

Hereinafter, a method of manufacturing the image drum 100 will be described.

The flexible substrate 120 on which a plurality of the ring electrodes 125 is formed is manufactured. The flexible substrate 120 may be formed of polyimide, or other suitable material known in the art, and a copper pattern may be formed on the flexible substrate 120 through a conventional photolithographic process or screen printing process, or similar process known in the art. Before attaching the flexible substrate 120 to the drum body 110, the ring electrodes 125 are formed in the shape of a straight line, parallel and regularly disposed while maintaining a width of approximately 20 μm on the flexible substrate 120.

After providing the flexible substrate 120 on which the ring electrodes 125 are formed, the control unit 130, for example, an ASIC chip, is bonded along one end of the flexible substrate 120. An application specific IC (ASIC) chip may be used as the control unit. A number of ASIC chips can also be mounted on the flexible substrate by means of bonding. The control unit 130 is for applying voltage individually to each of the ring electrodes 125 and may be electrically coupled to the ring electrodes 125 by a general die bonding or soldering, or other similar process known in the art.

Generally, an insulating layer is formed above the flexible substrate 120 and the ring electrode 125. The insulating layer may be formed of a dielectric material such as, for example, AlN , Al₂O₃, or other similar dielectric material known in the art. The ring electrodes 125 can be electrically insulated from one another by the insulating layer. The insulating layer may be formed before and/or after the control unit 130 is mounted to the flexible substrate 120.

After the ring electrodes 125 and the control unit 130 have been integrally formed on the flexible substrate 120, the flexible substrate 120 enables the ring electrode 125 formed on the flexible substrate 120 to form a plane and an outer surface of opposite ends of the flexible substrate 120 are disposed to face each other. The control unit 130 and the facing part of the flexible substrate 120 are inserted into the slit 112 formed on the drum body 110. Since the slit 112 contains the control unit 130, and the control unit 130 and the flexible substrate 120 are inserted into the slit 112, it is advantageous to have no protrusions from the image drum 100. After inserting the control unit 130 and the facing part of the flexible substrate 120 into the slit 112, the control unit 130 and the facing part of the flexible substrate 120 are moved to the inside of the slit 112 to attach the flexible substrate 120 to an outer surface of the drum body 110, thereby manufacturing the complete image drum 100.

### Exemplary Embodiment 2

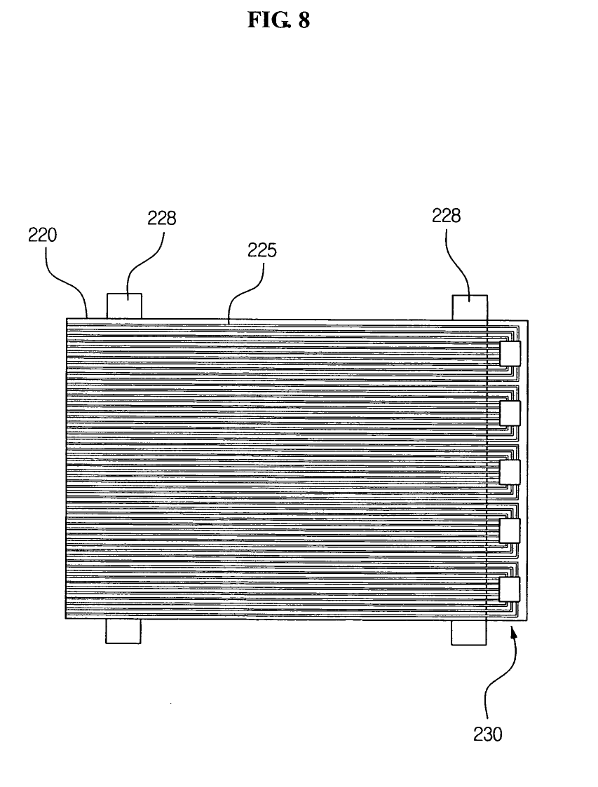

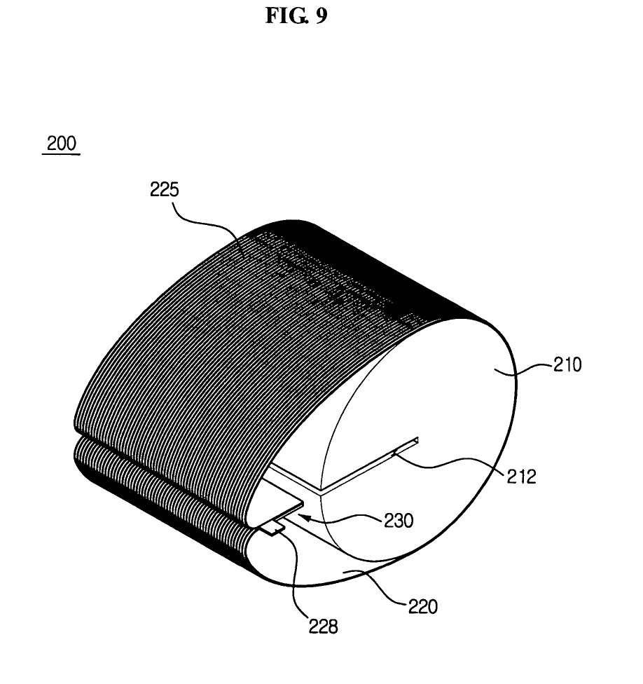

FIG. 8 is a top view illustrating a flexible substrate of an image drum according to a second exemplary embodiment of the present invention, and FIG. 9 is a perspective view illustrating a process of manufacturing an image drum according to the second exemplary embodiment of the present invention.

Referring to FIGS. 8 and 9, the image drum 200 includes a drum body 210, a flexible substrate 220, and control units 230.

The drum body 210 and the control units 230 of this second exemplary embodiment are substantially identical with the drum body 110 and the control units 130 of the first exemplary embodiment. Accordingly, with respect to the description of the drum body 210 and the control unit 230, the description and the drawings with respect to the drum body 110 and the control units 130 of the first exemplary embodiment may be referred to and a repeated description will thus be omitted.

In this second exemplary embodiment, array tags 228 for precisely arranging ring electrodes 225 on the flexible substrate 220 are formed. After disposing an outer surface of the flexible substrate 220 to face each other, the array tags 228 are pulled into the slit 212, thereby closely attaching the flexible substrate 220 to the drum body 220. Because the array tags 228 are used, right and left sides of the flexible substrate 220 may be easily aligned with each other, and a worker or an external device may easily pull the array tags 228 to move the flexible substrate 220 and the control units 230 into the slit 212.

The array tags are formed on a side of the flexible substrate 220 separated at an interval, and the array tags are respectively disposed adjacent to the opposite ends, the opposite ends being disposed to face each other. The interval may be predetermined. Accordingly, when the outer surface of opposite ends of the flexible substrate 220 are disposed to face each other, the array tags 228 may be disposed to be aligned with each other to precisely arrange the ring electrodes 225 of the flexible substrate 220. Also, when the control units 230 and the aligned part of the flexible substrate 220 are inserted into the slit longitudinally formed on the drum body 210 to contain the control unit 230, the array tags 228 are pulled to closely attach the flexible substrate 220 to the drum body 210.

Thus, though the control unit and a part of the flexible substrate, on which the control unit is formed, are inserted into the slit, the array tags are laterally extended and exposed from the slit, so that user or machine can easily grip and hold the array tags to insert them into the slit.

### Exemplary Embodiment 3

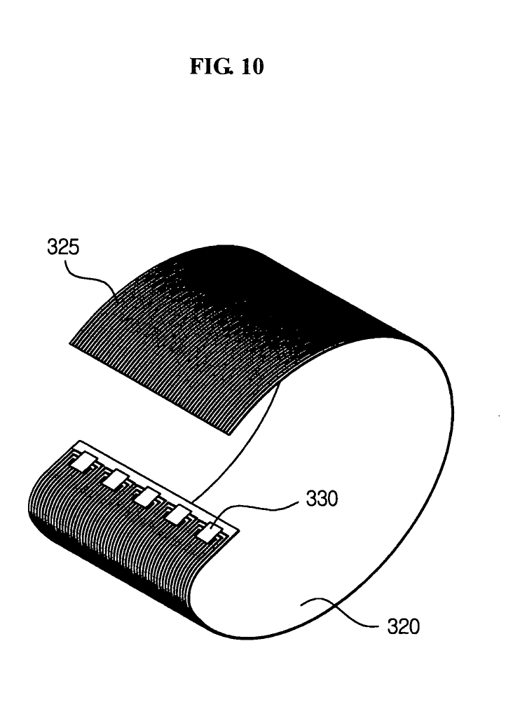

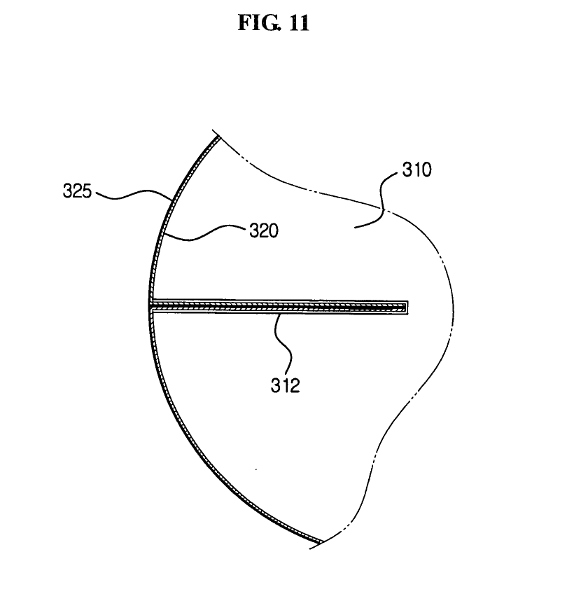

FIG. 10 is a perspective view illustrating a flexible substrate and ring electrodes according to a third exemplary embodiment of the present invention, and FIG. 11 is a partial enlarged cross-sectional view illustrating the image drum 300 according to the third exemplary embodiment of the present invention.

Referring to FIGS. 10 and 11, the image drum 300 includes a drum body 310, a flexible substrate 320, and control units 330.

The drum body 310 of this third exemplary embodiment is substantially identical with the drum body 110 of the first exemplary embodiment. Accordingly, with respect to the description of the drum body 310, the description and the drawings with respect to the drum body 110 of the first exemplary embodiment may be referred to and a repeated description will thus be omitted.

In this third exemplary embodiment, the control units 330 and ring electrodes 325 are formed on the same flexible substrate 320 and a part of the flexible substrate 320, on which the control units 330 are formed, is inserted into a slit 312 so as to be fixed.

### Exemplary Embodiment 4

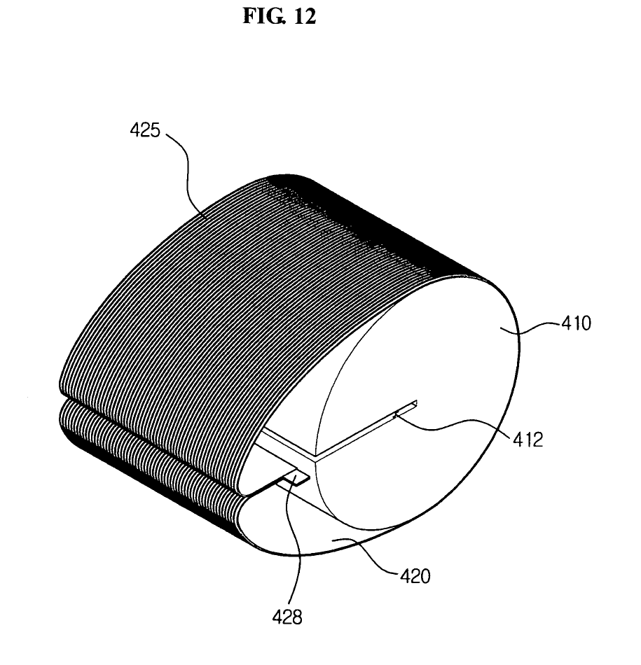

FIG. 12 is a perspective view illustrating a process of manufacturing an image drum according to a fourth exemplary embodiment of the present invention. Referring to FIG. 12, the image drum includes a drum body 410, a flexible substrate 420, and control units.

The drum body 410 and the flexible substrate 420 of this fourth exemplary embodiment are substantially identical with the drum body 310 and the flexible substrate 320 of the third exemplary embodiment. Accordingly, with respect to the description of the drum body 410 and the flexible substrate 420, the description and the drawings with respect to the drum body 310 and the flexible substrate 330 of the third exemplary embodiment may be referred to and a repeated description will thus be omitted.

In this fourth exemplary embodiment, array tags 428 are further provided in order to precisely align ring electrodes 425 on the flexible substrate 420 and closely attach the flexible substrate 420 to the drum body 410 by pulling the flexible substrate 420 into a slit 412.

The array tags 428 are formed on a side of the flexible substrate 420 separated at an interval, and the array tags 428 are disposed adjacent to the opposite ends respectively. Accordingly, when an outer surface of opposite ends of the flexible substrate 420 are disposed to face each other, the array tags 428 are disposed so as to be aligned with each other, thereby precisely aligning the ring electrodes 425 of the flexible substrate 420. Also, when the control units 430 and the aligned part of the flexible substrate 420 are inserted into the slit 412 longitudinally formed on the drum body 410 to contain the control units 430, the flexible substrate 420 may be easily attached to the drum body 410 by pulling the array tags 428.

### EXEMPLARY EMBODIMENT 5

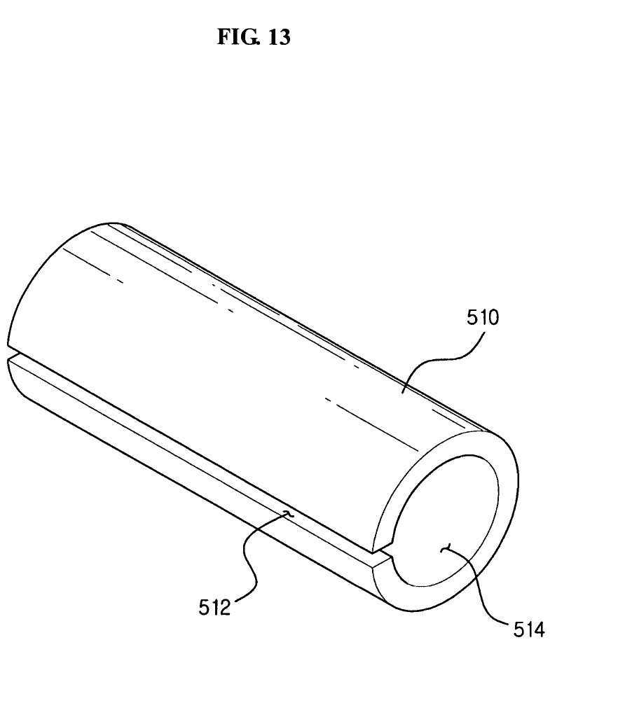

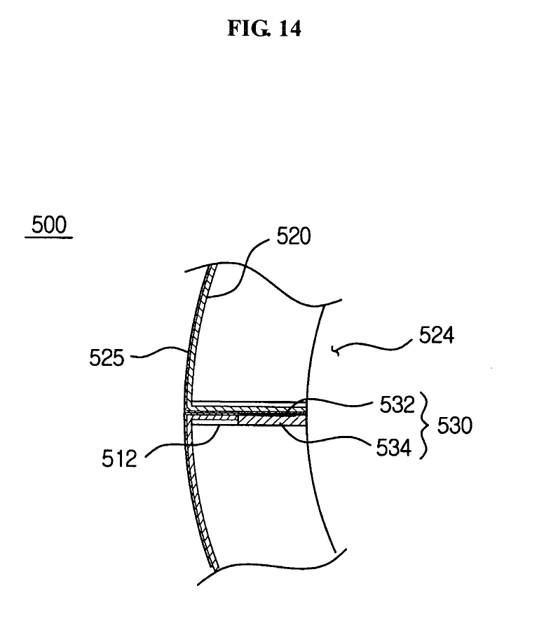

FIG. 13 is an enlarged perspective view illustrating a drum body of an image drum according to a fifth exemplary embodiment of the present invention, and FIG. 14 is a partial enlarged cross-sectional view illustrating the image drum according to the fifth exemplary embodiment of the present invention.

Referring to FIGS. 13 and 14, an image drum 500 includes a drum body 510, a flexible substrate 520, and control units 530.

The drum body 510 is formed in the shape of a hollow cylinder, in which a slit 512 is longitudinally formed to be extended from an outer surface to a hollowed center 514 thereof. The slit 512 is determined by a thickness of the control units 530 and the flexible substrate 520 on which the control units 530 are installed, in order to hold the control units 530. Also, the flexible substrate 520 is attached to an outer surface of the drum body 510.

The flexible substrate 520 may be manufactured by using a technology related to a conventional flexible printed circuit board (FPCB). Accordingly, the flexible substrate 520 may be formed of a thin insulating film composed of polyimide, or other such insulating film material known in the art. Conductive patterns may be circumferentially formed on the outer circumferential surface of the flexible substrate 520. The conductive patterns are evenly formed as ring electrodes 525 to have a pitch of approximately 40 μm and a width of approximately 20 μm. The ring electrodes 525 formed in the shape of a ring covering the circumference of the drum body 510 are formed to have a width corresponding to a printing width of a printing paper sheet. For example, assuming a printing paper sheet of A4 size, the drum body 510 is formed to have a length of at least 20 to 22 cm over the whole width thereof. However, this is only an example for purposes of illustration, and other widths are also contemplated. Each of the ring electrodes 525 may be formed to have a pitch of approximately 40 μm to achieve about five thousand lines. The ring electrode 525 can be formed in a ring structure in parallel with other ring electrodes 525 which are closed as one piece or partially opened. That is, both ends of each of the ring electrodes 525 may be electrically coupled to form a closed ring structure, but it is also possible to electrically insulate both ends of each ring electrode 525 according to circumstances.

Since the ring electrode 525 can be formed by patterning copper or other thin conductive film in a flat state, a groove cutting step or a conductive material filling step employed in the conventional image drum manufacturing process can be eliminated. Above all, since it is possible to form ring electrode 525 on the planar flexible substrate 520, the level of work difficulty is greatly lowered as compared to a formation of the ring electrodes 525 on the outer circumferential surface of the cylindrical drum body 510. Moreover, a defect generation rate of the ring electrodes 525 can be reduced.

After the ring electrodes 525 have been formed on the flexible substrate 520, a hard substrate 534 is bonded to the flexible substrate 520. A control chip 532 is connected to each ring electrode 525 on a one-to-one corresponding basis, and performs a switch function so as to individually apply a voltage to each electrode 525. The hard substrate 534 is installed to an end of the flexible substrate 520 and is inserted into the slit 512 together with the control chip 532.

Hereinafter, a method of manufacturing the image drum 500 according to an exemplary embodiment of the present invention will be described.

The flexible substrate 520 on which a plurality of the ring electrodes 525 is formed is manufactured. The flexible substrate 520 may be formed of polyimide, or other similar substrate material known in the art, and a copper pattern may be formed on the flexible substrate 520 via a conventional photolithographic process or screen printing process, or other similar process known in the art. Before attaching the flexible substrate 520 to the drum body 510, the ring electrodes 525 are formed in the shape of a straight line, parallel and regularly disposed while maintaining a width of approximately 20 μm on the flexible substrate 520.

After providing the flexible substrate 520 on which the ring electrodes 525 are formed, the control unit 530, for example an ASIC chip, or other similar control device known in the art, is bonded along one end of the flexible substrate 520. The control unit 530 is for individually applying voltage to each of the ring electrodes 525 and may be electrically coupled to the ring electrodes 525 by a general die bonding or soldering, or other similar method known in the art.

Generally, an insulating layer is formed above the flexible substrate 520 and the ring electrode 525. The insulating layer may be formed of a dielectric material such as, for example, AlN, Al₂O₃, or other similar material known in the art. Alternatively, the ring electrodes 525 can be electrically insulated from one another by the insulating layer. The insulating layer may be formed before and/or after the control unit 530 is mounted to the flexible substrate.

After forming the ring electrodes 525 on the flexible substrate 520, the control chip 532 for individually applying voltage to each of the ring electrodes 525 and the hard substrate 534 on which the control chip 532 are installed are bonded to the flexible substrate 520. Outer surfaces of opposite ends of the flexible substrate 520 are disposed to face each other.

After disposing the outer surfaces of the opposite ends of the flexible substrate 520, a part of the flexible substrate 520, to which the hard substrate 534 is installed, is inserted into the slit which extends from an outer surface of the drum body 510 to the hollowed center 514. The inserted part of the flexible substrate 520 to which the hard substrate 534 is installed is moved into the slit 512 and the flexible substrate 520 is attached to the outer surface of the drum body 510, thereby manufacturing the complete image drum 500.

The drum body 510 is formed in the shape of a hollow cylinder and may be formed of a material having excellent heat conductivity and mechanical strength, such as aluminum or other similar material known in the art. In the fifth exemplary embodiment, since the control chip 532 is inserted into the slit 512 and the flexible substrate 520 is formed of polyimide that has relatively low heat conduction, a phenomenon of heat accumulation may be generated in the image drum 510. Though the drum body 510 is formed of aluminum having excellent heat conductivity, heat may be not easily dissipated. Accordingly, in the fifth exemplary embodiment, since the drum body 510 is formed in the shape of a hollow cylinder, it is possible to easily circulate air to dissipate the heat.

Also, not shown, array tags may be further provided in the fifth exemplary embodiment in order to precisely align ring electrodes on a flexible substrate and closely attach the flexible substrate to a drum body by pulling the flexible substrate.

As described above, the image drum of exemplary embodiments of the present invention may be easily manufactured via processes of manufacturing an FPCB, bonding a chip to the FPCB, and covering a drum body with the FPCB formed in one body. Since the electrodes, which are easily manufactured, have a reduced defect generation rate and have high quality, a superior printing quality can be expected.

In addition, a manufacturing process of the image drum can be rapidly performed due to its structural simplicity, and is advantageous for mass production of the image drum according to exemplary embodiments of the present invention due to easy facilitation of each manufacturing steps. Above all, since it is possible to utilize a processing technology which is conventionally well known in the art, the manufacturing cost is reduced and the product cost can be lowered accordingly.

Moreover, since an image drum may be formed in the shape of a hollow cylinder, heat may be effectively dissipated and the image drum can be used for a long period without fault or inconvenience.

Although certain exemplary, non-limiting, embodiments of the present invention have been shown and described, the present invention is not limited to the described exemplary embodiments. Instead, it will be appreciated by those skilled in the art that changes may be made to these exemplary embodiments without departing from the principles and spirit of the invention, the scope of which is defined by the claims and their equivalents.

What is claimed is:

1. A method of manufacturing an image drum, the method comprising:
forming a plurality of electrodes, which are electrically insulated from each other and disposed parallel to each other, on a flexible substrate;
bonding a control unit to the flexible substrate;
disposing opposite ends of an outer surface of the flexible substrate to face each other;
inserting the control unit and the facing opposite ends of the flexible substrate into a slit which is longitudinally formed in a drum body; and
attaching the flexible substrate to an outer surface of the drum body.

2. The method of claim 1, wherein the plurality of electrodes are ring electrodes.

3. The method of claim 1, wherein the flexible substrate is attached to the outer surface of the drum body by moving the control unit and the opposite ends of the flexible substrate into the slit.

4. The method of claim 1, wherein, in disposing the opposite ends to face each other, both of the opposite ends of each of the plurality of ring electrodes are positioned such that the plurality of electrodes form a ring configuration.

5. The method of claim 1, wherein, in disposing the opposite ends to face each other, both of the opposite ends of each of the plurality of electrodes are positioned such that the opposite ends electrically couple with each other.

6. The method of claim 1, wherein inserting the control unit and the facing opposite ends into the slit further comprises precisely aligning the plurality of electrodes by laying array tags, which are formed on a side of the flexible substrate and disposed adjacent to the opposite ends respectively, one on top of another.

7. The method of claim 6, wherein the array tags are separated by a certain interval.

8. The method of claim 6, wherein the flexible substrate is closely attached to the drum body by pulling the array tags which have been laid one on top of another.

9. The method of claim 1, further comprising forming the control unit and the plurality of electrodes on the flexible substrate, and inserting the control unit and the facing opposite ends into the slit further comprises inserting a portion of the flexible substrate on which the control unit is formed into the slit in order to hold the control unit in the slit.

10. The method of claim 1, further comprising forming the control unit on a hard substrate, and inserting the control unit and the facing opposite ends into a slit further comprises inserting the control unit, which is formed on the hard substrate, into the slit.

11. A method of manufacturing an image drum, the method comprising:
forming a plurality of electrodes, which are insulated from each other and disposed parallel to each other, on a flexible substrate;
mounting a control chip on a hard substrate;
bonding the control chip and the hard substrate to the flexible substrate;
disposing opposite ends of an outer surface of the flexible substrate to face each other;
inserting the hard substrate and a part of the flexible substrate to which the hard substrate is bonded into a slit formed longitudinally in a drum body; and
attaching the flexible substrate to an outer surface of the drum body.

12. The method of claim 11, wherein the plurality of electrodes are ring electrodes.

13. The method of claim 11, wherein the flexible substrate is attached to the outer surface of the drum body by moving the hard substrate and inserted part of the flexible substrate into the slit.

14. The method of claim 11, wherein inserting the hard substrate into the slit holds the hard substrate in the slit.

15. The method of claim 11, wherein, in disposing the opposite ends to face each other, both of the opposite ends of each of the plurality of electrodes are positioned such that the opposite ends electrically couple with each other.

16. The method of claim 11, wherein disposing the opposite ends to face each other further comprises precisely aligning the plurality of electrodes by laying array tags, which are formed on a side of the flexible substrate and disposed adjacent to the opposite ends respectively, one on top of another.

17. The method of claim 16, wherein the array tags are separated at a certain interval.

18. The method of claim 16, wherein the flexible substrate is closely attached to the drum body by pulling the array tags which have been laid one on top of another.

19. An image drum comprising:
a drum body having a slit formed longitudinally therein;
a flexible substrate including a plurality of electrodes, electrically insulated from each other, disposed parallel to each other, and formed on an outer surface thereof, the flexible substrate attached to and covering the drum body while exposing the plurality of electrodes; and
a control unit which is inserted into the slit together with opposite ends of an outer surface of the flexible substrate.

20. The image drum of claim 19, wherein the plurality of electrodes are ring electrodes.

21. The image drum of claim 19, wherein the drum body is cylindrical in shape.

22. The image drum of claim 19, wherein both ends of each of the plurality of electrodes are electrically coupled to each other.

23. The image drum of claim 19, wherein array tags are formed on a side of the flexible substrate and disposed adjacent to the opposite ends respectively.

24. The image drum of claim 23, wherein the array tags are separated at a certain interval.

25. The image drum of claim 19, wherein the control unit and the plurality of electrodes are formed on the same flexible substrate and a part of the flexible substrate on which the control unit is formed is inserted into the slit in order to hold the control unit in place.

26. The image drum of claim 19, wherein the control unit is provided on a hard substrate and the hard substrate is inserted into the slit together with the control unit in order to hold the control unit in place.

27. An image drum comprising:
a drum body having a slit formed longitudinally therein;
a flexible substrate including a plurality of electrodes electrically insulated from each other, disposed parallel to each other, and formed on an outer surface thereof, the flexible substrate attached to and covering the drum body while exposing the plurality of electrodes; and
a control unit comprising a control chip and a hard substrate on which the control chip is bonded, the control unit being inserted into the slit together with contact ends of an outer surface of the flexible substrate.

28. The image drum of claim 27, wherein the plurality of electrodes are ring electrodes.

29. The image drum of claim 27, wherein the drum body is in a shape of a hollow cylinder.

30. The image drum of claim 27, wherein both ends of each of the plurality of electrodes are electrically coupled to each other.

31. The image drum of claim 27, wherein array tags are formed on a side of the flexible substrate and disposed adjacent to the opposite ends respectively.

32. The image drum of claim 31, wherein the array tags are separated at a certain interval.

33. The image drum of claim 27, wherein the control unit is inserted into the slit in order to hold the control unit in place.
